(19) United States
(12) Patent Application Publication
(10) Pub. No.: US 2021/0047170 A1
(43) Pub. Date: Feb. 18, 2021

(54) LIQUID OR DRY DRIP COLLECTOR FOR DISPENSING CONTAINERS

(71) Applicant: Curtis ARMACOST, Ewa Beach, HI (US)

(72) Inventor: Curtis ARMACOST, Ewa Beach, HI (US)

(21) Appl. No.: 16/539,307

(22) Filed: Aug. 13, 2019

(51) Int. Cl. B67D 1/16; B67D 1/00; B67D 1/08

(52) U.S. Cl. CPC B67D 1/16; B67D 1/0891; B67D 1/0042

(57) ABSTRACT

A liquid collector is configured to collect liquid escaping from a nozzle of a liquid container. The liquid collector includes an anchor portion configured to be sandwiched between the liquid container and a surface on which the liquid container rests. The liquid collector also includes a collection portion located below the anchor portion. The collection portion includes a basin configured to be positioned directly below the nozzle when the anchor portion is sandwiched between the liquid container and the surface. The liquid collector further includes a suspension portion configured to connect the collection portion to the anchor portion. The collection portion is suspended from the suspension portion.

### FIELD OF TECHNOLOGY

The subject matter disclosed herein relates to excess liquid and dry collection devices, and particularly relates to a liquid or dry leakage collector for liquid or dry items dripping or leaking from a dispensing container.

### BACKGROUND

Containers with spouts provide a cheap and simple means to supply liquid or dry items (e.g., cereal or candy) to a user. They are often used to provide liquid refreshment or food for athletes, restaurant customers, banquet attendees, office works, etc. Typically, such containers have a simple valve integrated into the spout and rely on gravity to direct the liquid or dry item through the spout. However, the valves often have small defects through wear or insufficient design, which can lead to undesired leakage or dripping. Also, improper use of the container can result in overflow and spillage. Spills, leaks, and drips can lead to slippery floors, stained floors, or unsightly and unsafe conditions.

One solution that has been employed is to design dispensing containers with an integrated collection tray below the spout. However, because the collection tray is integrated into the design of the dispensing container, the collection tray is only usable with that particular dispensing container. In addition, integrating a collection tray into the design of a dispensing container increases the complexity of the dispensing container and the costs of manufacturing the dispensing container.

Another solution that has been employed is to manufacture a trough that can be hung or suspended from the spout of the dispensing container. However, conventional spouts are not designed to have items hung from them. Over time, the weight of the liquid or dry items trapped in the trough could warp or damage the spout, thereby shortening the useful life of the spout and the dispensing container.

Also, spouts vary in size and shape. Thus, a trough that hangs from a spout of a dispensing container must be custom built for that dispensing container and likely cannot be used for other dispensing containers.

Furthermore, in order for a trough to be hung from the spout, the trough must be positioned in the particular space a user places a receptacle (e.g., bowl or cup) to receive the liquid or dry item from the spout. Thus, hanging a trough from a spout interferes with the usage of the spout which can lead to spills and overflow of the receptacle.

What is needed is a universal drip collector that can be used with dispensing containers having different shapes and sizes without shortening the useful life of the dispensing container and without increasing the complexity and manufacturing costs of the dispensing container.

### BRIEF SUMMARY

Aspects of the liquid or dry drip collector described herein provide solutions to one or more problems or disadvantages associated with the prior art.

One aspect of the technology relates to a liquid or dry drip collector configured to collect liquid or dry items escaping or leaking from a nozzle of a dispensing container. The collector may have an anchor portion configured to be sandwiched between the dispensing container and a surface on which the dispensing container rests so that the anchor portion may be secured to the surface by the weight of the dispensing container. A collection portion of the liquid or dry drip collector may be located below the anchor portion. The collection portion may comprise a basin configured to be positioned directly below the nozzle when the anchor portion is sandwiched between the dispensing container and the surface. The liquid or dry drip collector may further include a suspension portion configured to connect the collection portion to the anchor portion. The collection portion may be suspended from the suspension portion.

Another aspect of the technology relates to a liquid or dry drip collector configured to collect liquid or dry items escaping or leaking from a nozzle of a dispensing container. The collector may include a substantially planar anchor portion and a collection portion located below the anchor portion. The collection portion may include a basin. A top of the basin may be open. The liquid or dry drip collector may also include a vertically oriented suspension portion extending from the collection portion to the anchor portion. The anchor portion may extend rearwardly from a top portion of the suspension portion and the collection portion may project frontwardly from a bottom portion of the suspension portion.

Yet another aspect of the technology may include a liquid or dry drip collector configured to collect liquid or dry items escaping or leaking from a spout of a dispensing container. The collector may include an anchor portion, and a collection portion located below the anchor portion. The collection portion may include a basin, and a top of the basin may be open. The liquid or dry drip collector may also include a suspension portion that forms an L-shaped bracket with the anchor portion. The suspension portion may be suspended from the anchor portion, and the collection portion may be suspended from the suspension portion.

### BRIEF DESCRIPTION OF THE DRAWINGS

FIG. 1 is a perspective view of an exemplary liquid collector with a liquid container.

FIG. 2 is a perspective view of the liquid collector of FIG. 1.

FIG. 3 is a perspective view of another exemplary liquid collector.

FIG. 4 is another perspective view of the liquid collector of FIG. 3.

### DETAILED DESCRIPTION

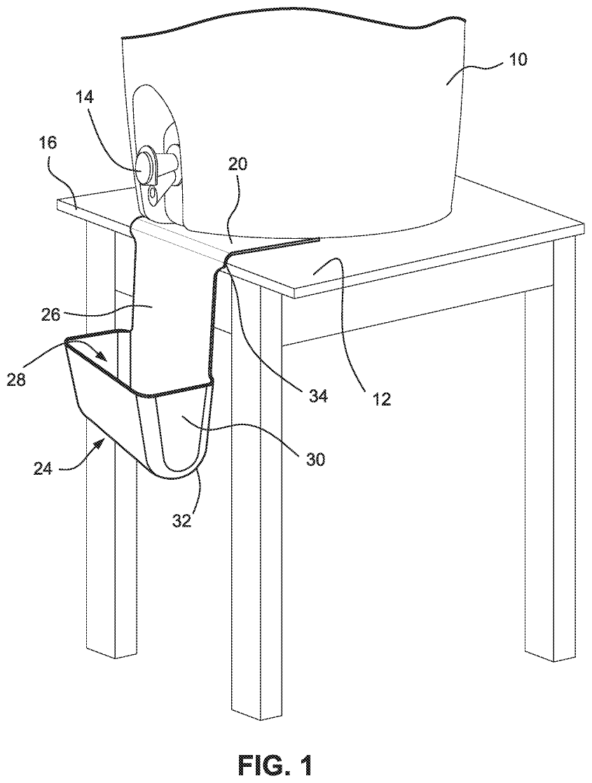

FIG. 1 shows a dispensing container 10 resting on a surface 12. The surface may be any horizontal surface such as a table, a desk, a chair, etc. In addition, the dispensing container 10 may include a dispenser 14, which may be in the form of, for example, a nozzle or a spout. The dispenser 14 may be located at a lower part of the dispensing container 10 so that gravity may force liquid or dry items through the dispenser 14 when a valve in the dispenser 14 is opened. It is contemplated that the dispensing container 10 may be positioned so that the dispenser 14 hangs over an edge 16 of the surface 12.

A liquid or dry item collector 18 may be secured to the surface 12 by the weight of the dispensing container 10. In particular, the dispensing container 10 may rest on top of an anchor portion 20 of the liquid or dry item collector 18. Because the liquid or dry item collector 18 may be held in place by the weight of the dispensing container 10, the liquid or dry item collector 18 may be used with many types of dispensing containers 10 having different shapes, sizes, and construction. Thus, the function of the liquid or dry item collector 18 described herein is not limited to collecting liquid or dry items from the particular dispensing container 10 illustrated in FIG. 1.

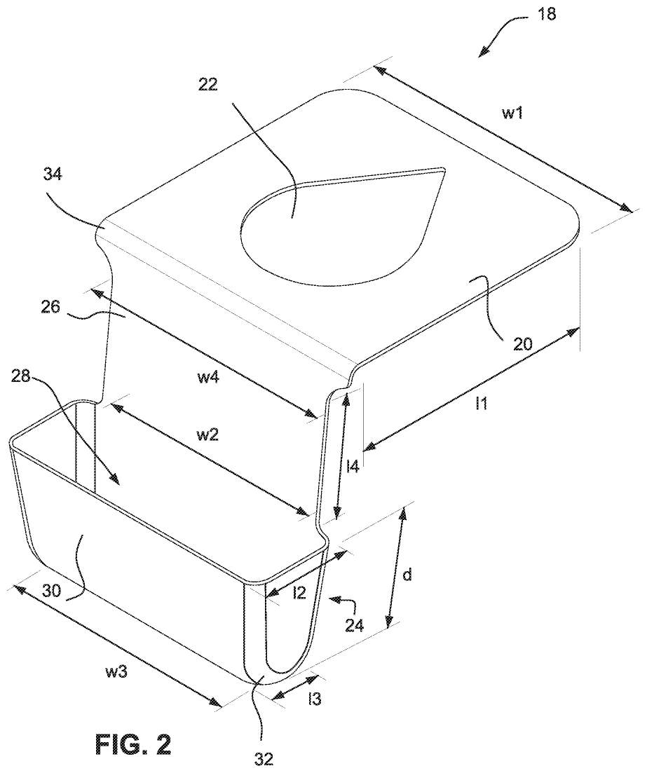

As can be seen in FIGS. 1 and 2, the anchor portion 20 may have a substantially planar shape and may extend horizontally. Although the anchor portion 20 is shown having a substantially rectangular footprint, the footprint of the anchor portion 20 may have any other shape. It is contemplated that the entire top surface of the anchor portion 20 may be flat to support the liquid container. However, the top surface of the anchor portion 20 may have one or more projections, bumps or rims that may help prevent the dispensing container 10 from sliding across the top surface of the anchor portion 20. Frictional forces generated in part by the weight of the dispensing container 10 may prevent the anchor portion 20 from sliding off of the surface 12.

The anchor portion 20 may include an opening 22 in a central region of the anchor portion 20. The opening 22 may be optional and may help reduce the cost of manufacturing by reducing the amount of material needed to form the anchor portion 20. As will be explained later, the opening 22 may also play a role in expanding the footprint of the anchor portion 20. Although the opening 22 is illustrated as being tear shaped, it is contemplated that the opening 22 may be any size or shape as long as the opening 22 does not comprise the rigidity of the anchor portion 20 and the ability of the anchor portion 20 to remain fixed under the dispensing container 10.

It is contemplated that a width w₁ of the anchor portion 20 may be within a range of about 6 inches to about 12 inches. Preferably, the width w₁ of the anchor portion 20 may be about 8 inches. It is further contemplated that the length l₁ of the anchor portion 20 may be within a range of about 6 inches to about 12 inches. Preferably, the length l₁ of the anchor portion 20 may be about 8 inches.

The liquid or dry item collector 18 may further include a collection portion 24 and a suspension portion 26. As can be seen in FIGS. 1 and 2, the collection portion 24 may be positioned below the anchor portion 20. The collection portion 24 may comprise a basin or trough 28 bounded by one or more side walls 30 and a base or bottom wall 32. It is contemplated that in some configurations, the side walls 30 may meet at a bottom point, thereby eliminating the need for a base or bottom wall 32. In addition, the top of the basin or trough 28 may be open. Making the entire top part of the basin or trough 28 open may provide a larger area that can receive falling liquid. Thus, the liquid or dry item collector 18 does not need to be precisely aligned with the dispenser 14 of the dispensing container 10. Instead, the liquid or dry item collector 18 can be off-center from the dispenser 14 and still collect liquid falling from the dispenser 14.

It is contemplated that a width w₂ of the basin 28 at the top of the collection portion 24 may be within a range of about 6 inches to about 12 inches. Preferably, the width w₂ of the basin 28 at the top of the collection portion 24 may be about 8 inches. It is further contemplated that the length l₂ of the basin 28 at the top of the collection portion 24 may be within a range of about 1 inch to about 5 inches. Preferably, the length l₂ of the basin 28 at the top of the collection portion 24 may be about 2¾ inches. In addition, a depth d of the basin 28 may be within a range of about 1 inch to about 6 inches. Preferably, the depth d of the basin 28 may be about 3½ inches. At the bottom of the collection portion 24, the width w₃ of the basin 28 may be within a range of about 6 inches to about 12 inches. Preferably, the width w₃ of the basin 28 at the bottom of the collection portion 24 may be about 7¼ inches. In addition, the length l₃ of the basin 28 at the bottom of the collection portion 24 may be within a range of about 1 inch to about 5 inches. Preferably the length l₃ of the basin 28 at the bottom of the collection portion 24 may be about 2 inches.

The suspension portion 26 may connect the collection portion 24 to the anchor portion 20. In addition, the suspension portion 26 may be suspended from the anchor portion 20, while the collection portion 24 may be suspended from the suspension portion 26. The suspension portion 26 may be substantially flat and may be vertically oriented. The suspension portion 26 may function as the backbone of the liquid or dry item collector 18 by providing the structural support to allow the liquid or dry item collector 18 to maintain its shape. Accordingly, the suspension portion 26 may be rigid.

Although the suspension portion 26 is shown as being as wide as the anchor portion 20 and the collection portion 24, the suspension portion 26 may be wider than or narrower than the anchor portion 20 and/or the collection portion 24. In addition, although the suspension portion 26 is shown as being one solid component, it is contemplated that the suspension portion 26 may have an opening similar to the anchor portion 20. It is further contemplated that the suspension portion 26 may comprise multiple separate vertical components extending from the anchor portion 20 to the collection portion 24.

It is contemplated that a width w₄ of the suspension portion 26 may be within a range of about 6 inches to about 12 inches. Preferably, the width w₄ of the suspension portion 26 may be about 8 inches. It is further contemplated that the length l₄ of the suspension portion 26 may be within a range of about 6 inches to about 12 inches. Preferably, the length l₄ of the suspension portion 26 may be about 4½ inches.

For all configurations of the liquid or dry item collector 18, the entire unit may be integrally formed as one piece. Alternatively, the anchor portion 20, the collection portion 24, and the suspension portion 26 may be modular components. In addition the liquid or dry item collector 18 may be molded from a plastic resin. Alternatively, the liquid or dry item collector 18 may be formed from a metal or other material than can be manipulated into the continuous shape illustrated in FIGS. 1 and 2 (e.g., paper, wood, stainless steel, etc.). In addition, it is contemplated that the entire liquid or dry item collector 18 may be rigid so as to maintain its form. It is contemplated that the liquid or dry item collector 18 may be disposable if made of, for example, paper. In addition, if made of paper, the liquid or dry item collector 18 may be lined with wax or some other waterproof material that may also give the liquid or dry item collector 18 some structural support to maintain its form.

The liquid or dry item collector 18 may have an S-shape or a Z-shape. In particular, the anchor portion 20 may extend horizontally from a top of the suspension portion 26 in a rearward direction. At the same time, the collection portion 24 may project from a bottom of the suspension portion 26 in a forward direction. In other words, the anchor portion 20 and the collection portion 24 may extend or project from the suspension portion 26 in opposite lateral directions.

In addition, the top of the suspension portion 26 may meet the anchor portion 20 at an edge 34. In other words, the top of the suspension portion 26 may form a front edge of the anchor portion 20. In this configuration, the anchor portion 20 and the suspension portion 26 may form an L-shaped bracket. The L-shaped bracket may allow the liquid or dry item collector 18 to remain attached to the surface 12 even when the dispensing container 10 is removed.

When attached to the surface 12, the suspension portion 26 may be positioned against a front edge of the surface 12. In other words, the edge 34 may be aligned and may rest against a front edge of the surface 12. In addition, the edge 34 may be a sharp edge or may be filleted or curved to accommodate surfaces 12 of different shapes. Thus, filleting the edge 34 may increase the universality of the liquid or dry item collector 18 by allowing the liquid collector to be secured to different surface shapes.

The bottom of the suspension portion 26 may form part of the basin 28. For example, the bottom of the suspension portion 26 may form a rear wall of the basin 28.

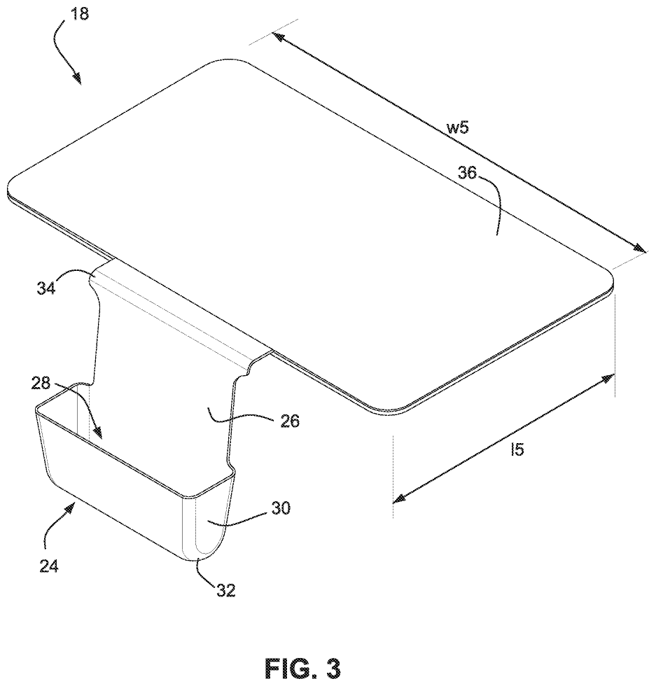

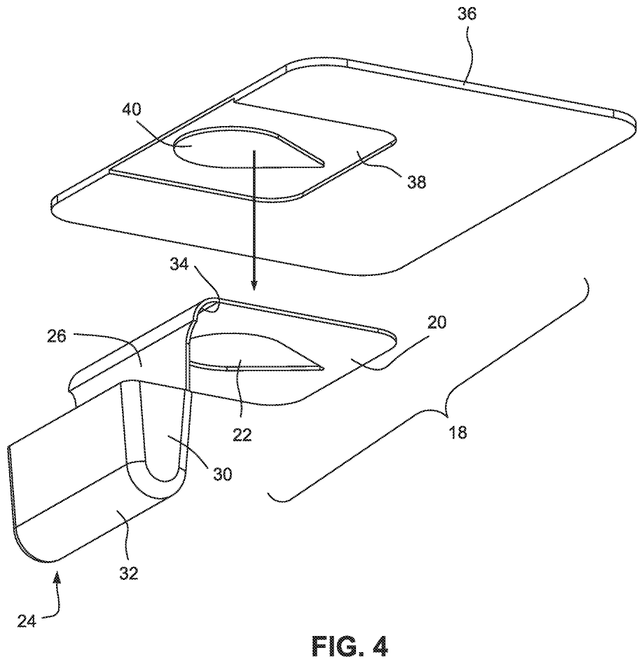

Some dispensing container 10 may be raised onto a plurality of legs. For such dispensing containers 10, the bottom surface may be elevated off of the surface 12 so that the only contact between the anchor portion 20 and the dispensing container 10 is at the legs. In addition, the legs could be spread out further than the footprint of the anchor portion 20. FIGS. 3 and 4 show an exemplary configuration of the anchor portion 20 that can accommodate such a situation.

FIG. 3 shows an expander 36 overlaid on top of the anchor portion 20. The expander 36 may have a similar shaped footprint as the anchor portion 20. Alternatively, the footprint of the expander 36 may be different from the anchor portion 20. For example, a width w₅ of the expander 36 may be within a range of about 12 inches to about 24 inches. Preferably, the width w₅ of the expander 36 may be about 15 inches. It is further contemplated that the length l₅ of the expander 36 may be within a range of about 12 inches to about 24 inches. Preferably, the length l₅ of the expander 36 may be about 15 inches.

Similar to the anchor portion 20, the expander 36 may have a substantially planar shape and may be oriented horizontally so that the expander 36 may be positioned underneath the dispensing container 10. Also, similar to the anchor portion 20, the entire top surface of the expander 36 may be flat. Alternatively, the top surface of the expander 36 may have one or more projections, bumps or rims that may help prevent the dispensing container 10 from sliding across the top surface of the expander 36. Frictional forces generated in part by the weight of the dispensing container 10 may prevent the expander 36 and the anchor portion 20 from sliding off of the surface 12.

FIG. 4 shows the expander 36 separated from the anchor portion 20. As can be seen, the expander 36 may have a recess 38 having the same size and shape as the footprint of the anchor portion 20. In addition, the recess 38 may include a raised portion 40. Accordingly, when the expander 36 is secured to the anchor portion 20, the recess may receive the anchor portion 20. In addition, the opening 22 in the anchor portion 20 may receive the raised portion 40. The weight of the dispensing container 10 may press the expander 36 against the anchor portion 20 and may press the raised portion 40 into the opening 22, thereby interlocking the expander 36 to the anchor portion 20. When interlocked with the expander 36, the anchor portion 20 may be prevented from sliding out from under the expander 36.

It is contemplated that the bottom surface of the anchor portion 20 and the expander 36 may be treated to increase the surface roughness or surface tackiness and/or frictional forces between the surface 12 and the anchor portion 20 (and/or the expander 36). The bottom surfaces may be roughened, sanded, dimpled, sand blasted and/or coated.

For the purposes of this application, the term “about” when used to describe a dimensional refers to manufacturing tolerances.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A liquid or dry item collector configured to collect liquid or dry items escaping from a nozzle of a dispensing container, the liquid or dry item collector comprising:
an anchor portion configured to be sandwiched between the dispensing container and a surface on which the dispensing container rests so that the anchor portion is secured to the surface by the weight of the dispensing container, wherein an opening is located in a central part of the anchor portion;
a collection portion located below the anchor portion, the collection portion comprising a basin configured to be positioned directly below the nozzle when the anchor portion is sandwiched between the dispensing container and the surface; and
a suspension portion configured to connect the collection portion to the anchor portion, the collection portion being suspended from the suspension portion.

2. The liquid or dry item collector of claim 1, further comprising an expander plate removably attached to the anchor portion, the expander plate having a larger footprint than the anchor portion and being configured to support the dispensing container.

3. The liquid or dry item collector of claim 1, wherein the anchor portion, the collection portion, and the suspension portion are integrally formed.

4. The liquid or dry item collector of claim 1, wherein the anchor portion has a planar shape.

5. The liquid or dry item collector of claim 1, wherein the anchor portion, the suspension portion, and the collection portion together form a Z-shape or an S-shape.

6. The liquid or dry item collector of claim 1, wherein the suspension portion forms a wall bounding the basin of the collection portion.

7. A liquid or dry item collector configured to collect liquid or dry items escaping from a nozzle of a dispensing container, the liquid or dry item collector comprising:
a substantially planar anchor portion with an opening in a central part of the anchor portion;
a collection portion located below the anchor portion, the collection portion comprising a basin, a top of the basin being open; and
a vertically oriented suspension portion extending from the collection portion to the anchor portion,
wherein the anchor portion extends rearwardly from a top portion of the suspension portion and the collection portion projects frontwardly from a bottom portion of the suspension portion.

8. The liquid or dry item collector of claim 7, wherein the anchor portion, the collection portion, and the suspension portion are integrally formed together as a continuous rigid structure.

9. The liquid or dry item collector of claim 7, wherein the basin of the collection portion is bound by at least one side wall.

10. The liquid or dry item collector of claim 7, wherein the suspension portion forms a rear wall bounding the basin of the collection portion.

11. The liquid or dry item collector of claim 7, wherein a footprint of the anchor portion is substantially rectangular.

12. The liquid or dry item collector of claim 7, wherein the anchor portion comprises a substantially planar fixed part and a substantially planar expansion part, the fixed part being integrally formed with the suspension portion, and the expansion part being removably attachable to the fixed part.

13. The liquid or dry item collector of claim 12, wherein the expansion part has a larger footprint than the fixed part, and the expansion part is configured to be positioned on top of the fixed part.

14. A liquid or dry item collector configured to collect liquid escaping from a spout of a dispenser container, the liquid or dry item collector comprising:
an anchor portion;
a collection portion located below the anchor portion, the collection portion comprising a basin, a top of the basin being open; and
a suspension portion that forms an L-shaped bracket with the anchor portion,
wherein the suspension portion is suspended from the anchor portion and the collection portion is suspended from the suspension portion,
wherein the anchor portion has a first width, the suspension portion has a second width, and the first width is greater than the second width.

15. The liquid or dry item collector of claim 14, wherein the anchor portion, the collection portion, and the suspension portion are integrally formed together as a continuous rigid structure.

16. The liquid or dry item collector of claim 14, wherein the basin is below the suspension portion.

17. The liquid or dry item collector of claim 14, wherein the anchor portion and the collection portion project from the suspension portion in opposite lateral directions.

18. The liquid or dry item collector of claim 14, wherein a top of the suspension portion forms a front edge of the anchor portion and a bottom of the suspension portion forms a rear wall of the basin of the collection portion.

19. The liquid or dry item collector of claim 14, wherein the anchor portion comprises a substantially planar fixed part and a substantially planar expansion part, the fixed part being integrally formed with the suspension portion, and the expansion part being removably attachable to the fixed part.

20. The liquid or dry item collector of claim 19, wherein the expansion part has a larger footprint than the fixed part, and the expansion part is configured to be positioned on top of the fixed part.

21. The liquid or dry item collector of claim 1, wherein the opening is configured to receive an expander plate that has a larger footprint than the anchor portion.

22. The liquid or dry item collector of claim 2, wherein the expander plate comprises a projection having the same shape as the opening in the anchor portion, the opening in the anchor portion being configured to receive the projection of the expander plate.

23. The liquid or dry item collector of claim 1, wherein a joint between the anchor portion and the suspension portion has an axis, the anchor portion has a first width in a direction parallel to the axis of the joint, the suspension portion has a second width in the direction parallel to the axis of the joint, and the first width is greater than the second width.

24. The liquid or dry item collector of claim 23, wherein the collection portion has a third width in the direction parallel to the axis of the joint between the anchor portion and the suspension portion, the third width being greater than the second width.

25. The liquid or dry item collector of claim 7, wherein the opening is configured to receive an expander plate that has a larger footprint than the anchor portion.

26. The liquid or dry item collector of claim 13, wherein the opening is in the fixed part and the expansion part comprises a projection having the same shape as the opening in the fixed part, the opening in the fixed part being configured to receive the projection of the expansion part.

27. The liquid or dry item collector of claim 7, wherein the anchor portion has a first width, the suspension portion has a second width, and the first width is greater than the second width.

28. The liquid or dry item collector of claim 7, wherein the collection portion has a third width that is greater than the second width.

29. The liquid or dry item collector of claim 14, wherein the collection portion has a third width that is greater than the second width.

30. The liquid or dry item collector of claim 14, wherein the anchor portion comprises an opening in a central part, the opening being configured to receive a projection from an expander plate, the expander plate having a larger footprint than the anchor portion.
